(19) United States
(12) Patent Application Publication
(10) Pub. No.: US 2004/0062996 A1
(43) Pub. Date: Apr. 1, 2004

(54) Heat resistant lithium cell

(75) Inventors: Satoru Fukuoka, Sumoto-shi (JP); Seiji Morita, Sumoto-shi (JP); Nobuhiro Nishiguchi, Sumoto-shi (JP); Satoru Naruse, Sumoto-shi (JP); Masayuki Muraki, Mihara-gun (JP); Masahiro Imanishi, Tsuna-gun (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SANYO ELECTRIC CO., LTD., Osaka (JP)

(21) Appl. No.: 10/669,713

(22) Filed: Sep. 25, 2003

(30) Foreign Application Priority Data
Sep. 30, 2002 (JP) 2002-286103

(51) Int. Cl. H01M 10/40; H01M 4/50

(52) U.S. Cl. 429/341; 429/329; 429/330; 429/224; 429/231.1

(57) ABSTRACT

A lithium cell has a positive electrode, a negative electrode having lithium, a separator interposed between the positive electrode and the negative electrode, and a non-aqueous electrolytic solution containing a solute and a non-aqueous solvent. The non-aqueous solvent has a main component of one or more than one compound represented by the following general formula (1): X—(O—C₂H₄)n-O—Y (where X and Y are independently a methyl group or an ethyl group, and n is 2 or 3). The main component is 90 to 100% in volume of the non-aqueous solvent. The separator has a melting point of higher than 150° C. The lithium cell with the above construction does not impair heat resistant safety and electrochemical characteristics such as discharging characteristics even in severe environments of high temperature, and enhances its long period reliability.

### TECHNICAL FIELD

The present invention relates to a lithium cell that has high capacity and is excellent in heat resistant safety and in discharging characteristics.

### BACKGROUND ART

Conventional lithium cells can be used satisfactorily in temperature environments of up to 85° C. However, when lithium cells are incorporated into electrical components of vehicles (air-pressure gauges for tires, on-vehicle devices of the Electronic Toll Collection system, and the like), FA (Factory Automation) appliances, and the like, the cells are often exposed to harsh temperature environments of over 100 to 150° C. In view of this, in such fields of application, there is a strong need for lithium cells that do not reduce their cell characteristics even in environments of high temperature and that are used safely.

When the cells are incorporated into electronic appliances, the technique of reflow soldering is employed to enhance productivity. With this technique, cell temperature reaches, though only temporarily, as high as 200 to 260° C. because of the reflow heating. In view of this, there is also a need for highly reliable lithium cells that do not deteriorate their cell characteristics upon exposure to reflow heating.

As a technique to enhance discharging characteristics of secondary lithium cells, there is proposed a technique in which electrochemically and thermally stable organic acid lithium salts such as lithium bis (trifluoromethanesulfonyl) imide (LiN(CF₃SO₂)₂) serve as the solute and certain organic ether compound serves as the main solvent of the electrolytic solution (see, for example, Japanese Patent Publication No. H11-26016, Reference 1).

As a technique to enhance discharging characteristics of secondary lithium cells and to impart high temperature resistivity thereto, there is proposed a technique in which the main solvent of the electrolytic solution is tetraglime (tetraethylene glycol dimethyl ether) that has a high boiling point (275° C.) above reflow temperature, and the separator and gasket are made of complex material whose thermal softening temperature is increased up to near 250° C. by adding fillers such as glass fibers in polyphenylene sulfide (see, for example, Japanese Patent Publication No. 2000-173627, Reference 2).

However, cells that employ the technique disclosed in Reference 1 have insufficient heat resistance because the separator and gasket used here are made of low heat-resistant polypropylene (melting point: approximately 150° C.). For this reason, these cells cannot be used in the above fields of application, where a long period of stability against temperatures of near 150° C. is required, and also cannot survive reflow soldering, where a cell is exposed to temperatures of at least 200° C.

On the other hand, although cells that employ the technique disclosed in Reference 2 have excellent heat resistance, the viscosity of the non-aqueous electrolytic solution is high because the main solvent is highly viscous tetraglime (tetraethylene glycol dimethyl ether). This results in poor discharging characteristics.

### SUMMARY OF THE INVENTION

The present inventors, as a result of an extensive study conducted in view of the foregoing problems, have disproved the conventionally common technical idea that in heat resistant cells, a solvent that has a boiling point higher than the desired heat resistance temperature should be used. Instead, the present inventors have found that a solvent with a relatively low boiling point such as diethylene glycol dimethyl ether (boiling point: 162° C.) and triethylene glycol dimethyl ether (boiling point: 216° C.) should be employed, and that by combining such a solvent with a heat resistant separator, satisfactory safety is secured even in severe environments of high temperature above the boiling point of the solvent while remarkably increasing discharging characteristics.

It is an object of the present invention to provide a lithium cell that is excellent in heat resistant safety and in discharging characteristics.

A lithium cell according to the present invention comprises a positive electrode, a negative electrode having lithium, a separator interposed between the positive electrode and the negative electrode, and a non-aqueous electrolytic solution containing a solute and a non-aqueous solvent, the cell wherein the non-aqueous solvent has one or more than one compound represented by the following general formula (1), the one or more than one compound of the non-aqueous solvent, and the main component being 90% to 100% in volume of the non-aqueous solvent,

X—(O—C₂H₄)n-O—Y (1)

(where X and Y are independently a methyl group or an ethyl group, and n is 2 or 3); and wherein the separator has a melting point of higher than 150° C.

With this construction, in environments of high temperature of up to 150° C., the separator does not break or decompose upon heat softening, preventing cell abnormality resulting therefrom. In addition, the compound represented by the above general formula (1) is highly stable in chemical and thermal viewpoints despite its relatively low relative dielectric constant. Therefore, when such a compound is used as a main component (content: 90 to 100% in volume) of the electrolytic solution, the safety and discharging characteristics of the cell in environments of high temperature are balanced at a high level. This prevents cell abnormality resulting from a thermal excursion reaction between the electrodes and the electrolytic solution, and enhances cell characteristics.

In the lithium cell according to the present invention, the non-aqueous solvent may include, as a subsidiary component, cyclic ester carbonate or cyclic lactone.

With this construction, the safety and discharging characteristics of the cell in environments of high temperature are balanced at a higher level. This is the effect of using, as a subsidiary solvent, the cyclic ester carbonate or cyclic lactone that has higher relative dielectric constant and a higher boiling point than those of the main solvent.

In the lithium cell according to the present invention, the solute may be lithium bis (trifluoromethanesulfonyl) imide or lithium bis (pentafluoroethanesulfonyl) imide.

These imide salts are highly stable in electrochemical and thermal viewpoints, and thus self-discharge of the cell is reduced. Therefore, with this construction, it is made possible to provide a cell in which deterioration of discharging characteristics is further inhibited in environments of high temperature.

In the lithium cell according to the present invention, the positive electrode may include a manganese oxide.

A positive electrode using a manganese oxide has high heat stability, and therefore, with this construction, it is made possible to provide a cell in which self-discharge is reduced (discharging characteristics are excellent) and safety is further enhanced.

Note that when the present invention is applied to a lithium secondary cell, it is preferable to use spinel type lithium manganese oxide as a positive-electrode active material because it is low cost and has high heat stability. It is also possible, however, to use other transition metal oxides that contain lithium. That is, it is not to exclude the use of lithium cobalt oxide (LiCoO₂) and lithium nickel oxide (LiNiO₂), which are high cost and have poor heat stability while having quite high energy density.

When a lithium alloy is used for the negative electrode, it is possible to use, as a positive-electrode active material, metal oxide that does not contain lithium such as manganese dioxide. Such metal oxide can be used alone or together with boron oxide contained therein.

When the present invention is applied to a lithium primary cell, it is necessary to use, as a positive-electrode active material, manganese dioxide, graphite fluoride, iron disulfide, iron sulfide, or the like. Manganese dioxide is preferred for its heat stability.

### BRIEF DESCRIPTION OF THE DRAWING

FIG. 1 is a schematic cross section of a flat lithium secondary cell that is taken an example of the present invention.

### DESCRIPTION OF THE PREFERRED EMBODIMENTS

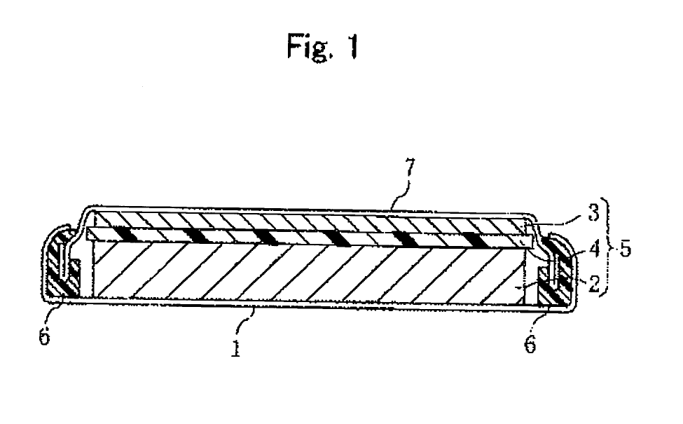

With reference to the drawing, embodiments of the present invention will be described with a flat lithium secondary cell taken as an example. FIG. 1 shows a cross section of the construction of this cell.

As shown in FIG. 1, this cell has a flat-shaped appearance and a cell outer housing can (positive electrode can) 1. In the positive electrode can 1, an electrode assembly 5 composed of a positive electrode 2, a negative electrode 3, and a separator 4 that separates the electrodes is encased. The separator 4 is filled with an electrolytic solution. This cell is sealed such that the opening portion of the positive electrode can 1 and a cell sealing can (negative electrode cap) 7 are caulked and fixed with the intervention of a ring-shaped insulating gasket 6.

The lithium secondary cell with the above structure was prepared as follows.

[Preparation of Positive Electrode]

Spinel type manganese oxide lithium (LiMn₂O₄) for serving as a positive-electrode active material, carbon black for serving as a conductant agent, and polyvinylidene fluoride for serving as a binding agent were mixed at a mass ratio of 94:5:1, respectively. This mixture was pressure-molded at a pressure of 9 ton/cm² in order to have a disc-shaped positive electrode pellet of 4 mm across and 0.5 mm thick. This positive electrode pellet was vacuum-dried (at 250° C. for 2 hours) to remove moisture out thereof. Thus, a positive electrode was prepared.

[Preparation of Negative Electrode]

The negative electrode cap used here was made of clad material composed of a stainless plate and an aluminum plate adhered to each other with the aluminum plate facing inside. A metal lithium plate was contact-bonded on the surface of the aluminum plate, which was the inner surface of the negative electrode cap, in order to prepare a disc-shaped negative electrode of 3.5 mm across and 0.2 mm thick. The metal lithium plate, which was contact-bonded on the surface of the aluminum plate, has an alloying reaction caused by charging and discharging after the sealing of the cell, and thus the active material of the negative electrode becomes a lithium-aluminum alloy.

[Preparation of Electrolytic Solution]

In diethylene glycol dimethyl ether (DGM) for serving as the solvent, 0.75 M (mole/liter) of LiN (CF₃SO₂)₂ for serving as the solute was dissolved to prepare an electrolytic solution.

[Preparation of Cell Structure]

A separator made of a nonwoven fabric of polyphenylene sulfide (PPS) was placed on the negative electrode, and the electrolytic solution was injected into the separator. Then, the positive electrode was placed on the separator, and a positive electrode can of stainless was further placed thereover. The positive electrode can and the negative electrode cap were caulked and sealed with the intervention of an insulating gasket made of polyether etherketone. Thus, a lithium secondary cell with a cell diameter (diameter) of 6 mm and a thickness of 2 mm was prepared. Note that PPS and polyether etherketone are resins of high heat resistances (melting point, PPS: approximately 280° C.; polyether etherketone: 340° C.).

Next, the present invention will be described in further detail based on, but not limited to, the following Examples and Comparative Examples.

### EXAMPLE 1

A lithium secondary cell used in Example 1 was one prepared in the same manner as the above embodiment.

### EXAMPLE 2

A cell was prepared in the same manner as Example 1 except that as the solvent, triethylene glycol dimethyl ether (TRGM) was used instead of diethylene glycol dimethyl ether (DGM) used in Example 1.

### EXAMPLE 3

A cell was prepared in the same manner as Example 1 except that as the solvent, a mixture solvent of DGM and propylene carbonate (PC) mixed at a volume ratio of 99:1 (25° C., 101324.72 Pa), respectively, was used instead of using only diethylene glycol dimethyl ether (DGM) as in Example 1. Note that PC is known as a solvent having high relative dielectric constant (εᵣ=65) and high viscosity (η₀=2.5 cP).

### EXAMPLE 4

A cell was prepared in the same manner as Example 1 except that as the solvent, a mixture solvent of DGM and propylene carbonate (PC) mixed at a volume ratio of 97:3 (25° C., 101324.72 Pa), respectively, was used instead of using only diethylene glycol dimethyl ether (DGM) as in Example 1.

### EXAMPLE 5

A cell was prepared in the same manner as Example 1 except that as the solvent, a mixture solvent of DGM and propylene carbonate (PC) mixed at a volume ratio of 95:5 (25° C., 101324.72 Pa), respectively, was used instead of using only diethylene glycol dimethyl ether (DGM) as in Example 1.

### EXAMPLE 6

A cell was prepared in the same manner as Example 1 except that as the solvent, a mixture solvent of DGM and propylene carbonate (PC) mixed at a volume ratio of 90:10 (25° C., 101324.72 Pa), respectively, was used instead of using only diethylene glycol dimethyl ether (DGM) as in Example 1.

### EXAMPLE 7

A cell was prepared in the same manner as Example 1 except that as the solvent, a mixture solvent of DGM and ethylene carbonate (EC) mixed at a volume ratio of 99:1 (25° C., 101324.72 Pa), respectively, was used instead of using only diethylene glycol dimethyl ether (DGM) as in Example 1. Note that EC is known as a solvent having high relative dielectric constant (εᵣ=90) and high viscosity (η₀=1.9 cP).

### EXAMPLE 8

A cell was prepared in the same manner as Example 1 except that as the solvent, a mixture solvent of DGM and ethylene carbonate (EC) mixed at a volume ratio of 97:3 (25° C., 101324.72 Pa), respectively, was used instead of using only diethylene glycol dimethyl ether (DGM) as in Example 1.

### COMPARATIVE EXAMPLE 1

A cell was prepared in the same manner as Example 1 except that 1, 2-dimethoxyethane (DME), which is a common electrolytic solution solvent, was used instead of diethylene glycol dimethyl ether (DGM) used as the solvent in Example 1. Note that DME is known as a solvent having low relative dielectric constant (εᵣ=7.2) and low viscosity (η₀=0.46 cP).

### COMPARATIVE EXAMPLE 2

A cell was prepared in the same manner as Example 1 except that as the solvent, propylene carbonate (PC) was used instead of diethylene glycol dimethyl ether (DGM) used in Example 1.

### COMPARATIVE EXAMPLE 3

A cell was prepared in the same manner as Example 1 except that as the solvent, tetraethylene glycol dimethyl ether (TEGM) was used instead of diethylene glycol dimethyl ether (DGM) used in Example 1.

### COMPARATIVE EXAMPLE 4

A cell was prepared in the same manner as Example 1 except that a separator made of a nonwoven fabric of low cost, common polypropylene (PP) and a gasket of polypropylene (PP) were used instead of the separator made of a nonwoven fabric of polyphenylene sulfide (PPS) and the gasket made of polyether etherketone used in Example 1. Note that PP resin is known for having low heat resistance (melting point: approximately 150° C.).

### COMPARATIVE EXAMPLE 5

A cell was prepared in the same manner as Example 1 except that as the solvent, a mixture solvent of DGM and propylene carbonate (PC) mixed at a volume ratio of 70:30 (25° C., 101324.72 Pa), respectively, was used instead of using only diethylene glycol dimethyl ether (DGM) as in Example 1.

The following experiments 1 to 3 were conducted using the cells of Examples 1 to 8 and Comparative Examples 1 to 5. These experiments aimed at studying the long-period stability in environments of high temperature, reflow durability, and post-reflow discharging characteristics of a cell in relation to the solvent composition of the non-aqueous electrolytic solution or the material of the separator and gasket.

[Experiment 1]

Using the cells of Examples 1 and 2 and of Comparative Examples 1 to 3, a study was conducted on the long-period stability in high temperature environments, reflow durability, and post-reflow discharging characteristics of the cells in relation to the main solvents of the electrolytic solutions. Similarly, using the cells of Example 1 and Comparative Examples 4, a study was conducted to study the above characteristics of the cells in relation to the heat resistance of the resins used for the separators and gaskets.

<High Temperature Storage Test>

Each cell was put into a preservation chamber set at 150° C. and left standing for 30 days, followed by inspections of each cell for abnormality. The case where burst or leakage was found in the cell was evaluated abnormal, while the case without any abnormality being evaluated normal.

<Reflow Resistance Test>

Each cell was put into a reflow furnace that was set such that the surface temperature of the cell would reach a maximum of 260° C., and the entire body of each cell was exposed to a temperature of 200° C. for 100 seconds, followed by inspections of each cell for abnormality. The criteria for the abnormality inspections was the same as the high temperature preservation test.

<Measurement of Relative Discharging Capacity>

After subjected to the reflow resistance test, each cell was fully charged by applying them a uniform voltage of 3.0 V for 30 hours. Then, a constant-current discharging of 0.05 mA was conducted and the discharging capacity of each cell was measured until cell voltage reached 2.0 V. Using thus measured discharging capacity of each cell, relative discharging capacities were obtained in accordance with the following formula (1):

Relative Discharging Capacity (%)={(discharging capacity of each cell)/(discharging capacity of the cell of Example 1)}×100 (1)

The results of Test 1 are listed in Table 1.

TABLE 1

| | | | | high | reflow | relative |
|---|---|---|---|---|---|---|
| | | | | temperature | resistance | discharging |
| | solvent | separator | gasket | preservation test | test | capacity (%) |
| Example 1 | DGM | PPS | polyether | normal | normal | 100 |
| | | | etherketone | | | |
| Example 2 | TRGM | PPS | polyether | normal | normal | 97 |
| | | | etherketone | | | |
| Comparative | DME | PPS | polyether | abnormal | abnormal | — |
| Example 1 | | | etherketone | | | |
| Comparative | PC | PPS | polyether | abnormal | abnormal | — |
| Example 2 | | | etherketone | | | |
| Comparative | TEGM | PPS | polyether | normal | normal | 77 |
| Example 3 | | | etherketone | | | |
| Comparative | DGM | PP | PP | abnormal | abnormal | — |
| Example 4 | | | | | | |

The results of the high temperature preservation test and reflow resistance test were compared between Examples 1 and 2 and Comparative Examples 1 and 2. In the cells of Comparative Examples 1 and 2, in which a common electrolytic solution solvent 1, 2-dimethoxyethane (DME) or propylene carbonate (PC) was used, there was abnormality at the high temperature preservation test and reflow resistance test. On the other hand, there was no such abnormality found in the cells of Examples, in which diethylene glycol dimethyl ether (DGM) or triethylene glycol dimethyl ether (TRGM) was used as the solvent.

The abnormality is considered to have been caused because an excessively high temperature invited a thermal excursion reaction between lithium and DME or PC serving as the solvent. In addition, as especially for Comparative Example 1, the boiling temperature (84° C.) of DME was extremely low compared with reflow temperature (200° C. or higher, up to 260° C.), and thus DME was intensely evaporated, which is considered to be another factor.

In the cells of Examples 1, 2, and Comparative Example 3, there was no cell abnormality found at the high temperature preservation test and reflow resistance test. However, the cell of Comparative Example 3 showed a low value of 77% when relative discharging capacity was measured, while the cells of Examples 1 and 2 showing high relative discharging capacities of 100% and 97%, respectively. These results show that a cell using tetraethylene glycol dimethyl ether (TEGM) as the solvent allows a considerable decrease in discharging capacity, although it is seemingly resistant to reflow heating.

From the results of the high temperature preservation test and reflow resistance test conducted on the cell of Comparative Example 4, it has been confirmed that a cell using a separator and gasket made of low heat-resistant polypropylene (melting point: 150° C.) turns abnormal when exposed to severe environments of high temperature.

This abnormality is considered to have been caused mainly by a decrease in the sealing strength, which was a result of the thermal softening of the separator and gasket. This softening is because of the fact that the melting point of PP was lower than the specified temperatures of the tests. It is considered to be another factor of the abnormality that a reaction between the thermal-softened separator and the electrolytic solution caused the occurrence of a gas pressure.

From the results above, it has been proved that a cell provided with diethylene glycol dimethyl ether (DGM) or triethylene glycol dimethyl ether (TRGM) serving as a main solvent and with a heat resistant separator and gasket has resistances to a long period of high temperature heat and to an excessively high temperature at the reflow soldering step, although a high temperature is required only temporarily. It also has been proved that such a cell does not deteriorate its discharging characteristics upon exposure to reflow heating.

A study was conducted on the use of a solvent other than DGM and TRGM. As a result, it has been confirmed that any solvents that satisfy the above formula (1) can be advantageously used as a main solvent of the present invention. Such solvents include diethylene glycol diethyl ether, diethylene glycol methyl ethyl ether, triethylene glycol ethyl ether, triethylene glycol methyl ethyl ether, and the like.

[Experiment 2]

Using the cells of Examples 1, 3 to 8, and Comparative Example 5, a study was conducted on the composition ratio of a main component and a subsidiary component in a mixture solvent of the electrolytic solution in relation to the cell swelling rate and discharging characteristics of each cell after the reflow resistance test. Note that in principle a mixture solvent is provided with a main component and a subsidiary component; however, even when the main component constitutes 100% of the mixture solvent, such a solvent will be included in the category of a mixture solvent.

A similar reflow resistance test to Experiment 1 was conducted, and the entire length of each cell was measured thereafter. Using the measured values, the increased rate of entire cell length was obtained to study the effect of reflow heating on cell swelling. Similarly to Experiment 1, cell capacity after the reflow resistance test was measured and the relative discharging capacity (%) of each cell was obtained.

The results of Experiment 2 are listed in Table 2. Note that there was no cell abnormality in any of the examples after the reflow resistance test.

TABLE 2

| | | | | cell swelling by | relative |
|---|---|---|---|---|---|
| | main | subsidiary | mixture ratio | reflow resistance | discharging |
| | component | component | (main:subsidiary) | test (%) | capacity (%) |
| Example 1 | DGM | — | — | 0.15 | 100 |
| Example 3 | DGM | PC | 99:1 | 0.60 | 103 |
| Example 4 | DGM | PC | 97:3 | 0.70 | 95 |
| Example 5 | DGM | PC | 95:5 | 1.25 | 90 |
| Example 6 | DGM | PC | 90:10 | 1.40 | 82 |
| Example 7 | DGM | EC | 99:1 | 0.50 | 103 |
| Example 8 | DGM | EC | 97:3 | 1.00 | 93 |
| Comparative | DGM | PC | 70:30 | 3.25 | 74 |
| Example 5 | | | | | |

As shown in Table 2, it has been found that when a mixture solvent of diethylene glycol dimethyl ether (DGM) and propylene carbonate (PC) or ethylene carbonate (EC) is used as the electrolytic solution, and when the DGM serving as the main component of the mixture solvent is 90 to 100% in volume (Examples 1 and 3 to 8), then cell swelling rate (increased rate of entire cell length) after the reflow resistance test is 1.40% or less and post-reflow relative discharging capacity is 82% or greater.

It has also has been found that when the DGM, serving as the main component of the mixture solvent, is 95 to 100% in volume (Examples 1, 3 to 5, 7, and 8), cell swelling rate (increased rate of entire cell length) after the reflow resistance test is 1.25% or less and post-reflow relative discharging capacity is 90% or greater.

Furthermore, it has been found that when the DGM, serving as the main component of the mixture solvent, is 99% in volume (Examples 3 and 7), cell swelling rate (increased rate of entire cell length) after the reflow resistance test is 0.60% or less and post-reflow relative discharging capacity is 103% or greater.

It is considered that the result that relative discharging capacity exceeded 100% in Examples 3 and 7 is because PC or EC, added to serve as the subsidiary component, enhanced the relative dielectric constant of the electrolytic solution. On the other hand, it is considered that the result that discharging capacity was less than 100% in Examples 4 to 6, 8, and Comparative Example 5, in which PC or EC exceeded 1% in volume, is because the adverse effect of a reaction between lithium and PC or EC in a high temperature outweighed the effect of enhancing relative dielectric constant due to the addition of the PC or EC.

A study was conducted on the use of a solvent other than DGM and TRGM. As a result, it has been confirmed that any solvents that satisfy the above formula (1) can be advantageously used as a main solvent of the present invention. Such solvents include diethylene glycol diethyl ether, diethylene glycol methyl ethyl ether, triethylene glycol ethyl ether, triethylene glycol methyl ethyl ether, and the like.

Further in Table 2, propylene carbonate (PC) or ethylene carbonate (EC) that had high relative dielectric constant was shown as a subsidiary component of the mixture solvent. Other than these, other cyclic ester carbonates such as butylene carbonate and cyclic lactones having high relative dielectric constant such as gamma-butyrolactone also have been confirmed usable advantageously as a subsidiary component.

From the results above, to realize a cell that keeps post-reflow cell leakage low and has good discharging capacity, the cell should have the following solvent of the electrolytic solution. The solvent should be a mixture solvent composed of a main component that has a constitutional formula represented by the above formula (1) and constitutes 90 to 100%, preferably 95 to 100%, and more preferably 99% in volume (25° C., 101324.72 Pa) of the solvent; and of a subsidiary component of cyclic ester or cyclic lactone of 0 to 10%, preferably 0 to 5%, and more preferably 1% in volume.

[Supplementary Remarks]

The application of the present invention is not limited to lithium secondary cells such as those described in the above examples; it is applicable to any lithium cells such as lithium primary cells, where similar excellent effects are obtained.

In the present invention, in sealing the opening portion of the cell outer housing can, the sealing technique may be that of laser irradiation instead of caulking with the use of a gasket.

The cell of the present invention endures over a long period of use in severe environments of high temperature. For that purpose, the separator should be made of material that has a high heat melting temperature of preferably over 150° C., more preferably over the melting temperature of reflow soldering (185° C.), particularly preferably over the minimum reflow temperature (200° C.), and most preferably over the maximum reflow temperature (260° C.).

The above materials include, other than the aforementioned polyphenylene sulfide and polyether etherketone, heat resistant resins such as polyether ketone, polybutylene terephthalate, and cellulose, or resins whose heat resistance temperatures are enhanced by adding fillers such as glass fiber in the resin materials.

When the gasket is used for sealing the cell, in viewpoints of the heat resistant reliability of the cell, the material of the gasket is preferably a resin that satisfies the heat melting temperature conditions for the material of the separator.

As has been described above, the present invention realizes a lithium cell that is used safely for a long period in high temperature environments of 100 to 150° C. and that inhibits the deterioration of discharging characteristics even in such high temperature environments. Since such a cell of the present invention is excellent in safety and heat resistance, when the cell is constructed, it is possible to employ the technique of reflow soldering, which entails a high temperature of 200 to 260° C., although such high temperatures are required as temporarily as 100 seconds. In this case as well, there is no breakage of the cell structure or cell performance upon exposure to reflow heating.

What is claimed is:

1. A lithium cell comprising a positive electrode, a negative electrode having lithium, a separator interposed between the positive electrode and the negative electrode, and a non-aqueous electrolytic solution containing a solute and a non-aqueous solvent, wherein:
the non-aqueous solvent has one or more than one compound represented by the following general formula (1), the one or more than one compound being a main component of the non-aqueous solvent, and the main component being 90% to 100% in volume of the non-aqueous solvent,
X—(O—C₂H₄)n-O—Y (1)
(where X and Y are independently a methyl group or an ethyl group, and n is 2 or 3); and
the separator has a melting point of higher than 150° C.

2. The lithium cell according to claim 1, wherein the non-aqueous solvent includes cyclic ester carbonate or cyclic lactone, the cyclic ester carbonate or the cyclic lactone being a subsidiary component.

3. The lithium cell according to claim 1, wherein the solute is lithium bis (trifluoromethanesulfonyl) imide or lithium bis (pentafluoroethanesulfonyl) imide.

4. The lithium cell according to claim 1, wherein the positive electrode includes a manganese oxide.

5. The lithium cell according to claim 4, wherein the manganese oxide is a spinel type lithium manganese oxide.
